(19) United States
(12) Patent Application Publication
(10) Pub. No.: US 2022/0214437 A1
(43) Pub. Date: Jul. 7, 2022

(54) Underground Radar Device and Measuring Method

(71) Applicant: Nippon Telegraph and Telephone Corporation, Tokyo (JP)

(72) Inventors: Shoji Mochizuki, Musashino-shi, Tokyo (JP); Masayuki Tsuda, Musashino-shi, Tokyo (JP)

(21) Appl. No.: 17/608,952

(22) PCT Filed: May 27, 2019
(86) PCT No.: PCT/JP2019/020902

§ 371 Date: Nov. 4, 2021

(51) Int. Cl. G01S 13/04; G01N 22/00; G01C 9/02; G01C 22/00; G01S 7/04

(52) U.S. Cl. CPC G01S 13/04; G01N 22/00; G01S 7/04; G01C 22/00; G01C 9/02

(57) ABSTRACT

A ground penetrating radar device of the present embodiment is a manually operable device, in which encoders are attached to axles of three wheels that are mutually displaced by 120 degrees. A control unit calculates, from rotation amounts measured by the encoders, the moving direction, moving distance, moving speed vector, and turning vector of the ground penetrating radar device. A measurement unit searches for an underground buried object with radio wave. A storage unit stores a two-dimensional measurement data set, in which positional information and moving direction of the ground penetrating radar device calculated by the control unit is associated with measurement data obtained by a radar measurement unit. A display unit displays a facility map indicating the position where an underground structure is present, which is stored in a database, together with the measurement data while superimposing the facility map and the measurement data one on the other.

### TECHNICAL FIELD

The present invention relates to a ground penetrating radar technique for searching for an underground buried object.

### BACKGROUND ART

There are many buried objects under roads such as sidewalks and driveways. Further, there are cavities that may cause collapses or the like. In order to efficiently investigate the presence, scale, position, shape and the like of such buried objects and cavities from a position above the ground without excavation, ground penetrating radar devices using radio waves are utilized.

In particular, as ground penetrating radar devices dedicated to sidewalks, wheelbarrow (cart) type ground penetrating radar devices each having a small turning radius and primarily aiming to observe the inside of the ground are adopted widely. The cart-type ground penetrating radar devices are classified into the large-sized cart type equipped with multiple antennas and configured to cover a wide area and the small-sized cart type equipped with a set of high-performance antennas and being compact and having a small turning radius. Further, the scanning mechanism is classified into the traction type that performs scanning while dragging so as to cope with various road surface shapes and the wheel type that can scan flat road surfaces comfortably and quickly.

Conventional ground penetrating radar devices are often the wheel type requiring a small force as a device performing scanning, in consideration of workability from a relationship between device scale and weight. Among them, utilized popularly is the three-wheel type equipped with two wheels arranged in parallel and the remaining one wheel having a degree of freedom, for translatory movement and turning movement.

### CITATION LIST

### Non-Patent Literature

Non-Patent Literature 1: Fernando I. Rial, Manuel Pereira, Henrique Lorenzo, Pedro Arias, Alexandre Novo, “USE OF GROUND PENETRATING RADAR AND GLOBAL POSITIONING SYSTEMS FOR ROAD INSPECTION”, internet<https://carreteras-laser-escaner.blogspot.com/2014/08/use-of-ground-penetrating-radar-and.html>
Non-Patent Literature 2: Adriana SAVIN, Nicoleta IFTIMIE, Gabriel Silviu DOBRESCU, “Location of buried water pipes using evanescent electromagnetic waves”, 11th European Conference on Non-Destructive Testing (ECNDT 2014), Oct. 6-10, 2014, Prague, Czech Republic

### SUMMARY OF THE INVENTION

### Technical Problem

The conventional wheel-type ground penetrating radar devices are specialized in linear data measurement and therefore cannot obtain the amount of movement during turning. Further, a space larger than the device size is required to turn the ground penetrating radar device. Therefore, the conventional ground penetrating radar devices cannot perform measurement of movement when the line is not straight, there is a problem that it is difficult to perform measurement of movement on a minute and complicated route.

When one scanning cannot cover the measurement in the entire measurement area, it is necessary to set a plurality of measurement lines in the measurement area and start the measurement while placing the ground penetrating radar device at a reference position for each measurement line.

Even when the measurement is performed at the same spot, the intensity of a reflected wave is variable depending on the polarization direction of the electric field of the radio wave. The measurement in a different polarization direction greatly contributes to the improvement of accuracy in shape estimation and position identification of a buried object. In order to perform measurement in a different polarization direction, it is necessary to place the ground penetrating radar device at the reference position after changing the orientation (advancing direction) thereof to start the measurement.

The placement accuracy of the reference position directly influences the position accuracy of measurement data, but the position alignment accuracy depends on each worker. Therefore, there is a problem that obtaining a two-dimensional measurement data set having highly reproducible and highly accurate positional information is difficult.

The present invention has been made in view of the above problems and aims to provide a ground penetrating radar device capable of obtaining a two-dimensional measurement data set having higher position reliability.

### Means for Solving the Problem

A ground penetrating radar device according to the present invention is a manually operable ground penetrating radar device, including three omnidirectional wheels having axles angularly displaced from each other by 120 degrees, encoders attached to axles of the respective three omnidirectional wheels, a position measurement unit configured to obtain positional information and directional information of the ground penetrating radar device from rotation amounts of the axles measured by the encoders, a radar measurement unit configured to search for an underground buried object with radio wave, a database storing a facility map indicating a position where the underground buried object is present, a storage unit configured to store a two-dimensional measurement data set in which measurement data obtained by the radar measurement unit is associated with the positional information and the directional information, and a display unit configured to display the facility map and the measurement data while superimposing the facility map and the measurement data one on the other.

A measurement method according to the present invention is a measurement method that is executed by a manually operable ground penetrating radar device that includes three omnidirectional wheels having axles angularly displaced from each other by 120 degrees. The method includes a step of obtaining positional information and directional information of the ground penetrating radar device from rotation amounts of the axles of the three omnidirectional wheels, a step of searching for an underground buried object with radio wave, a step of storing a two-dimensional measurement data set in which measurement data measured by the radar measurement unit is associated with the positional information and the directional information, and a step of displaying a facility map indicating the position where the underground buried object is present together with the measurement data while superimposing the facility map and the measurement data one on the other.

### Effects of the Invention

According to the present invention, it is possible to provide a ground penetrating radar device capable of obtaining a two-dimensional measurement data set having higher position reliability.

### BRIEF DESCRIPTION OF DRAWINGS

FIG. 1 is a functional block diagram illustrating a configuration of a ground penetrating radar device of the present embodiment.

FIG. 2 is a diagram illustrating a moving mechanism of the ground penetrating radar device.

FIG. 3 is a diagram explaining a measurement area of polarized wave H obtained by radar measurement.

FIG. 4 is a diagram explaining a measurement area of polarized wave V obtained by radar measurement.

FIG. 5 is a diagram explaining an inclination map that can be obtained by an inner world sensor.

FIG. 6 is a diagram explaining a road surface map in which road surface images captured by a camera are combined.

FIG. 7 is a diagram explaining a facility map stored in a database.

FIG. 8 is a diagram explaining a topographic map stored in the database.

FIG. 9 is a diagram illustrating a display example in which the maps of FIGS. 3 to 8 are superimposed with each other.

FIG. 10 is a diagram explaining processing for identifying the position of the ground penetrating radar device on the facility map.

FIG. 11 is a diagram illustrating radar measurement at a spot where the depth to a buried pipe is known.

FIG. 12 is a diagram illustrating differences in propagation time between surface reflected wave and buried pipe reflected wave.

FIG. 13 is a diagram illustrating a movement locus for obtaining measurement data while moving the ground penetrating radar device in an up-and-down direction.

FIG. 14 is a diagram illustrating measurement data of polarized wave H obtained from the movement locus of FIG. 13.

FIG. 15 is a diagram illustrating a movement locus for obtaining measurement data while moving the ground penetrating radar device in a right-and-left direction.

FIG. 16 is a diagram illustrating measurement data of polarized wave V obtained from the movement locus of FIG. 15.

FIG. 17 is a diagram illustrating a turning movement.

FIG. 18 is a diagram illustrating measurement data obtained from the turning movement of FIG. 17.

### DESCRIPTION OF EMBODIMENTS

Hereinafter, embodiments of the present invention will be described with reference to attached drawings.

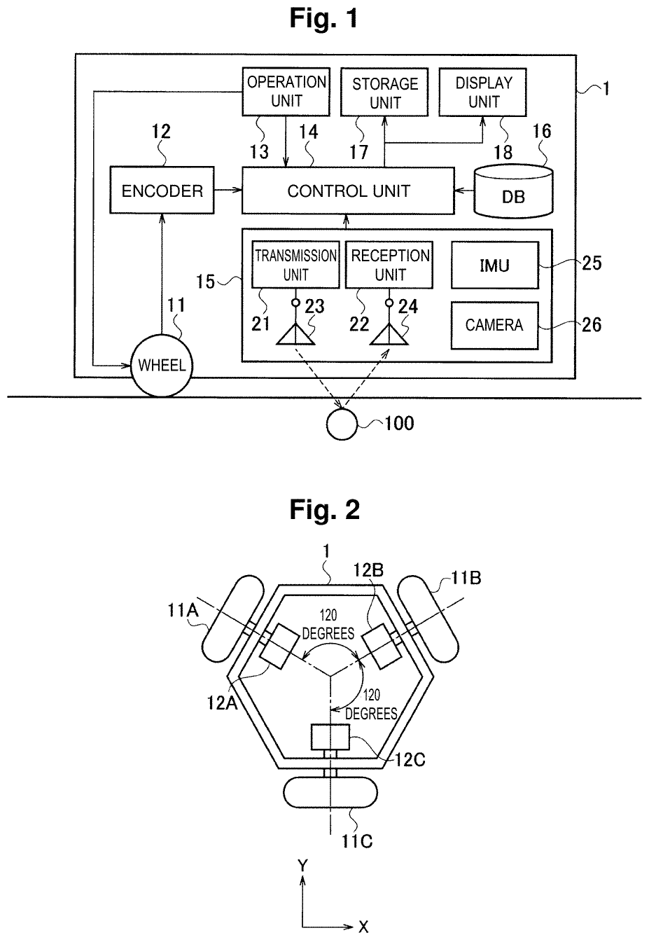

A ground penetrating radar device of the present embodiment will be described with reference to FIG. 1 and FIG. 2. The ground penetrating radar device 1 of the present embodiment includes wheels 11, encoders 12, an operation unit 13, a control unit 14, a measurement unit 15, a database 16, a storage unit 17, and a display unit 18.

The ground penetrating radar device 1 includes, as a moving mechanism, three wheels 11A to 11C each having the same size, as illustrated in FIG. 2. Three wheels 11A to 11C are arranged in such a manner that their centers are positioned on vertices of an equilateral triangle. The directions of the axles of respective wheels 11A to 11C are angularly displaced from each other by 120 degrees, and the circumferential directions of the wheels 11A to 11C are angularly displaced from each other by 60 degrees.

The wheels 11A to 11C used in this embodiment are omnidirectional wheels (omni wheels) including, on their outer rings, rollers each rotating in a direction orthogonal to the circumferential direction and movable in arbitrary two-dimensional directions. Using omni wheels as the wheels 11A to 11C enables the ground penetrating radar device 1 to freely move around in a two-dimensional plane without changing the orientation of the main body thereof. Further, it is possible to cause the ground penetrating radar device 1 to turn at the same spot.

Encoders 12A to 12C measuring the amount of rotation of corresponding axles are attached to the axles of the wheels 11A to 11C. The amount of rotation measured by the encoders 12A to 12C can be used to calculate the moving direction, moving distance, moving speed vector, and turning vector of the ground penetrating radar device 1, and positional information and directional information of the ground penetrating radar device 1 can be obtained.

The operation unit 13 is a handle for manually moving the ground penetrating radar device 1. The operation unit 13 may include an input device, such as a button for sending an instruction to the control unit 14. For example, a worker presses a measurement start button to instruct the control unit 14 to start measurement, and then, operates the handle to cause the ground penetrating radar device 1 to move in the back-and-forth direction, or in the right-and-left direction, or turn to perform scanning in a measurement area.

The control unit 14 is a central processing unit (CPU), which controls the entire processing of the ground penetrating radar device 1. For example, the control unit 14 executes processing for obtaining the positional information and directional information of the ground penetrating radar device 1 from the amount of rotation of each axle, processing for acquiring measurement data from the measurement unit 15 at predetermined intervals, processing for obtaining the absolute position of the ground penetrating radar device 1 by collating a facility map with radar measurement data, processing for obtaining the permittivity of the underground from radar measurement data, processing for storing the positional information and directional information while associating them with various measurement data, and processing for layer-displaying various measurement data, the facility map, and a topographic map on the display unit 18.

The measurement unit 15 includes a radar measurement unit composed of a transmission unit 21, a reception unit 22, and antennas 23 and 24, and further includes an inner world sensor (IMU) 25 and a camera 26. The measurement unit 15 measures various data, based on the instruction from the control unit 14, at predetermined timings.

The radar measurement unit searches for an underground buried object with radio wave. The transmission unit 21 transmits radio waves, via the antenna 23, toward the underground. The radio waves are reflected by the ground surface and a buried pipe 100. The reception unit 22 detects reflected waves received by the antenna 24. The radar measurement unit can identify the position where the buried pipe 100 is present based on the propagation time from transmission of the radio wave to detection of the reflected wave.

A plurality of sets of the antennas 23 and 24 may be mounted in a direction orthogonal to the advancing direction. For example, when the Y-axis direction of FIG. 2 is the advancing direction, multiple sets of the antennas 23 and 24 may be arranged side by side in the X-axis direction. This makes it possible to obtain radar measurement data in a two-dimensional plane (XY plane) during one scanning.

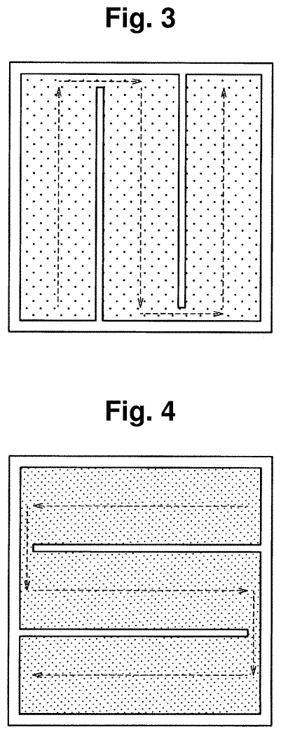

Scanning the measurement area by changing the orientation of the ground penetrating radar device 1 and obtaining polarization of the radio wave from the directional information can acquire radar measurement data decomposed into polarized components. FIG. 3 illustrates a measurement area of polarized wave H measured by radar while moving the ground penetrating radar device 1 in the Y-axis direction in a state where the ground penetrating radar device 1 is oriented in the same direction as that in FIG. 2. FIG. 4 illustrates a measurement area of polarized wave V measured by radar while moving the ground penetrating radar device 1 in the X-axis direction in a state where the ground penetrating radar device 1 is rotated in a counterclockwise direction by 90 degrees from the direction of FIG. 2. Even at the same spot, the reflected wave intensity is variable depending on the relationship between the polarization direction of the radio wave electric field and the extension direction of the buried pipe 100. Specifically, the reflected wave intensity is strongest when the polarization direction and the extension direction are parallel. Acquiring the radar measurement data decomposed into polarized components can visualize the underground with high accuracy.

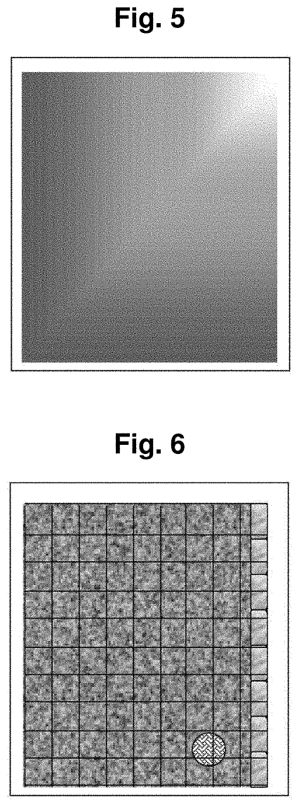

The IMU 25 is, for example, an acceleration sensor or a gyro sensor. The IMU 25 measures inclination information of a travelling surface of the ground penetrating radar device 1. FIG. 5 illustrates, as an inclination map, an exemplary display of the inclination information obtained by the IMU 25. Generating the inclination map can reliably reproduce a three-dimensional space. In general, in the case of generating a three-dimensional stereoscopic image by radar signal processing, it is assumed that the measurement area is a flat two-dimensional plane. In a place where the distance to an object may change, for example, when the measurement area is an inclined surface, the three-dimensional stereoscopic image cannot be reproduced accurately with the measurement data. The inclination map can be used to obtain positional information on a stereoscopic plane, and provides an added value in contributing to higher accuracy and higher resolution of a three-dimensional stereoscopic image generation in the radar signal processing.

The camera 26 captures a road surface image in the measurement area at predetermined intervals. FIG. 6 illustrates, as a road surface map, an exemplary display of a combination of road surface images obtained by the camera 26.

Using the inclination map and the road surface map in addition to the positional information obtained from the encoder can estimate the self-position with high accuracy. Further, storing the inclination map and the road surface map in a time series manner can monitor the secular change of the external situation and is useful in factor analysis at the time of abnormality detection under the ground.

The database 16 stores the facility map and the topographic map.

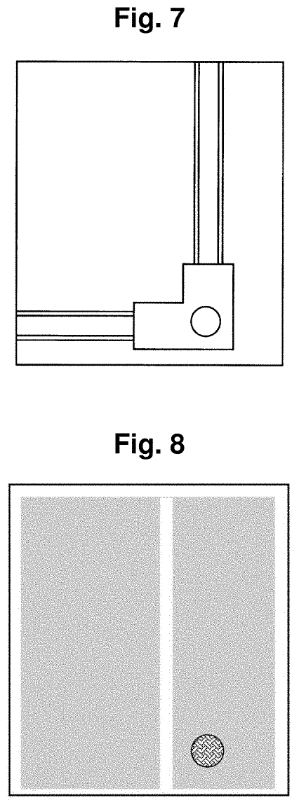

The facility map is a map indicating the position where a buried underground structure, including a manhole and pipes, is present. FIG. 7 illustrates an example of the facility map. Knowing the positions of facilities in advance can easily estimate an object from a radar image. As a result, it is expected that the accuracy in searching for a buried object will be improved and the work efficiency will be improved.

The topographic map indicates map information of the measurement area. The topographic map is a map indicating positional information of, for example, a sidewalk and a manhole. FIG. 8 illustrates an example of the topographic map. In the topographic map of FIG. 8, a roadside belt and a manhole are illustrated. Displaying the topographic map can acquire peripheral information.

Displaying the facility map and the topographic map to visualize a measurement range can reduce the burden of a worker during measurement.

The storage unit 17 receives the positional information, the directional information, and the measurement data from the control unit 14, associates the measurement data with the positional information and the directional information, and stores the associated data as a two-dimensional measurement data set. Regarding the measurement data of the radar measurement unit, the storage unit 17 may store measurement data for each of the polarized components illustrated in FIGS. 3 and 4.

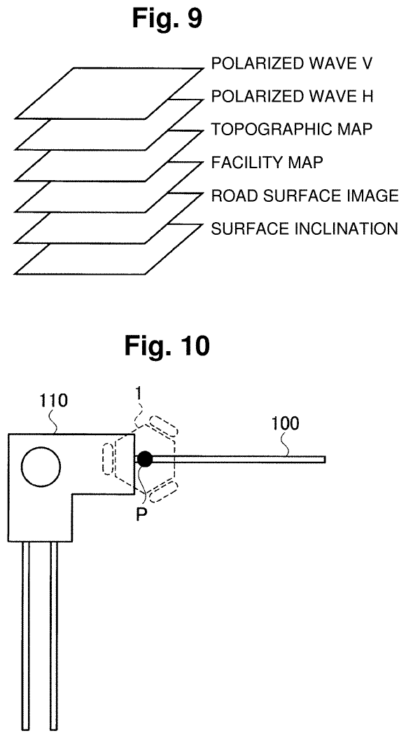

The display unit 18 layer-displays various measurement data, the facility map, and the topographic map. FIG. 9 illustrates an example of the layer display. For example, various measurement data of FIGS. 3 to 6, the facility map of FIG. 7, and the topographic map of FIG. 8 are displayed in a superimposed manner. The display unit 18 may be configured to enable a worker to designate a layer to be displayed or designate the order of layers to be displayed. Further, the display position of each layer may be shiftable to align the positions of respective layers.

Causing the display unit 18 to display the measurement data superimposed on the facility map and the topographic map can visualize the measurement area in a manner that a worker can easily understand. Therefore, the efficiency in a measurement work can be improved, and the effect of preventing overlooking in abnormality detection by collating with facility information on the facility map can be obtained.

Processing for matching the measurement data with the facility map will be described with reference to FIG. 10.

The positional information of the ground penetrating radar device 1 obtained from the amount of rotation measured by the encoder 12 is relative. In order to more accurately display the measurement data superimposed on the facility map and the topographic map, it is necessary to accurately identify the position of the ground penetrating radar device 1 on the facility map. Although it is conceivable to use a satellite positioning system, such as a global navigation satellite system (GNSS), to identify the position of the ground penetrating radar device 1, the position detection accuracy is insufficient compared to the position detection accuracy by the encoder and there is a problem that the position accuracy deteriorates in urban areas.

Therefore, in the present embodiment, a spot that can be identified by the radar measurement is defined as a base point, on the premise that the absolute position on the facility map corresponding to this spot is known, and the positional information of the measurement data is aligned with the position on the facility map based on the base point.

Large-sized structures, such as manholes, do not cause any secular change in their positions. The position of each pipe protruding from a sidewall of a manhole does not change. It is easy to detect the sidewall of each manhole in radar measurement. Therefore, detecting a pipe protruding from the sidewall of a manhole is easy.

Utilizing the fact that the ground penetrating radar device is freely movable in arbitrary two-dimensional directions, the radar measurement is performed by moving the ground penetrating radar device 1 in a local area near a manhole structure 110. As illustrated in FIG. 10, the position of the buried pipe 100 protruding from a sidewall of the manhole structure 110 is identified, from the measurement data, and is determined as a base point P. Since position coordinates of the buried pipe 100 protruding from the sidewall of the manhole structure 110 are known on the facility map, relative positional information at the base point P of the ground penetrating radar device 1 is made correspondence with position coordinates of the base point P on the facility map. As a result, the relative positional information of the ground penetrating radar device 1 obtained from the encoder 12 can be converted into position coordinates on the facility map, and the display unit 18 can display various measurement data superimposed on the facility map. Further, the storage unit 17 can manage various measurement data in association with position coordinates on the facility map.

As described above, using the position coordinates on the facility map to express the positional information of the base point P of the ground penetrating radar device 1 obtained by the encoder makes it possible to manage the measurement data with absolute positional information. After that, it becomes easy to compare acquired measurement data in time series, and accordingly deterioration and abnormality can be detected at early stage through secular change observation.

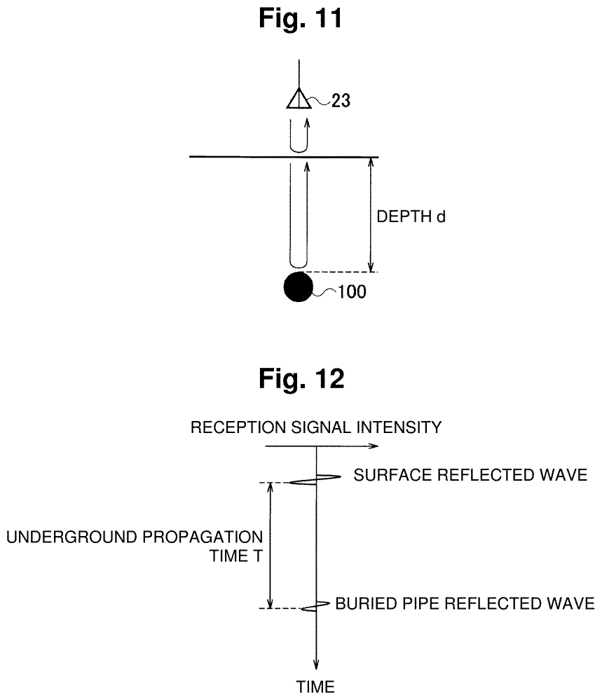

Processing for obtaining an edaphic relative permittivity will be described with reference to FIG. 11 and FIG. 12.

The edaphic relative permittivity can be obtained from radar measurement data at a spot directly above a buried object, the depth of which is known from the facility information on the facility map.

As illustrated in FIG. 11, at a spot where a depth d from the ground surface to the buried pipe 100 is known, the ground penetrating radar device 1 emits radio waves via the antenna 23 toward the underground. A part of the radio waves is reflected on the ground surface and observed as surface reflected waves. A part of the radio waves not reflected on the ground surface propagates in the ground, and is reflected on the buried pipe 100 and observed as buried pipe reflected waves.

As illustrated in FIG. 12, an underground propagation time T can be obtained from differences in propagation time between the surface reflected wave and the buried pipe reflected wave.

A radio wave propagation speed v in the soil is expressed by the following expression using light speed c and edaphic relative permittivity εr.

$$v = \frac{c}{\sqrt{{ɛ}_{r}}} \qquad Math . 1$$

The radio wave round-trip propagation distance in the soil is twice the depth to the buried pipe 100, and is equal to a distance corresponding to travelling at the propagation speed v for the underground propagation time T. Therefore, the following expression holds.

$$2 d = vT = \frac{c}{\sqrt{{ɛ}_{r}}} T \qquad Math . 2$$

Accordingly, the edaphic relative permittivity εr can be obtained by the following expression.

$${ɛ}_{r} = {( \frac{cT}{2 d} )}^{2} \qquad Math . 3$$

In general, the relative permittivity is unknown and is often empirically obtained. Therefore, it is difficult to improve the accuracy of position estimation in the depth direction. The ground penetrating radar device 1 of the present embodiment can obtain the edaphic relative permittivity εr by the above-described method, and therefore improvement of the position accuracy in the depth direction is expected. Obtaining the edaphic relative permittivity at a plurality of spots in the measurement area can cover a wide area in obtaining measurement values more accurately.

When the edaphic relative permittivity is known, it greatly contributes to the accuracy of image synthesis in radio wave propagation-based radar signal processing such as synthetic aperture and tomography, to which the relative permittivity contributes. As a result, the underground can be visualized with higher resolution and higher accuracy.

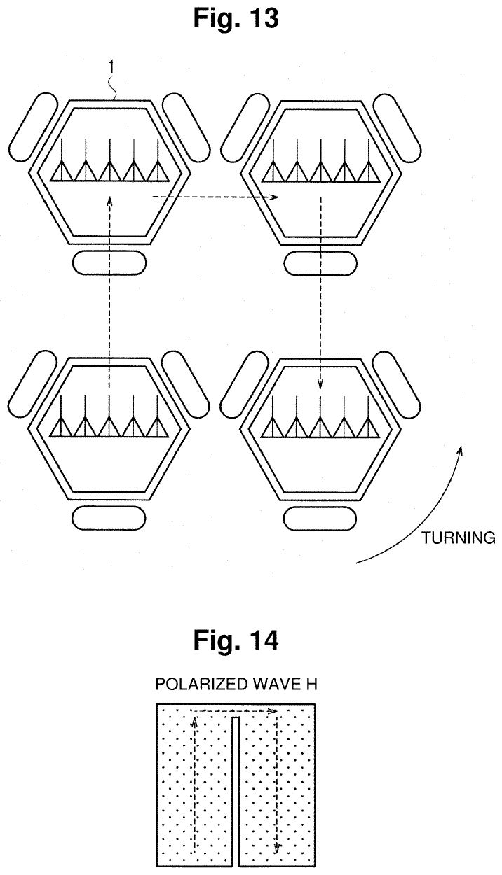

Single-stroke scanning realized by parallel translations and turning movements will be described with reference to FIG. 13 to FIG. 18.

The ground penetrating radar device 1 can move in back-and-forth and right-and-left directions without changing the orientation of the main body thereof, and positional information and directional information of the ground penetrating radar device can be accurately obtained based on axle rotation amounts measured by the encoders 12A to 12C.

As illustrated in FIG. 13, the ground penetrating radar device 1 is moved forward (upward in the drawing) to perform radar measurement, and then the ground penetrating radar device 1 is moved to the right without changing the orientation thereof so as to shift the measurement position. Subsequently, the ground penetrating radar device 1 is moved backward (downward in the drawing) to perform radar measures. Since the ground penetrating radar device 1 can move without changing the orientation thereof, it is possible to scan the measurement area by single-stroke movement and realize a continuous radar measurement. FIG. 14 illustrates measurement data of the polarized wave H obtained from the movement locus of FIG. 13.

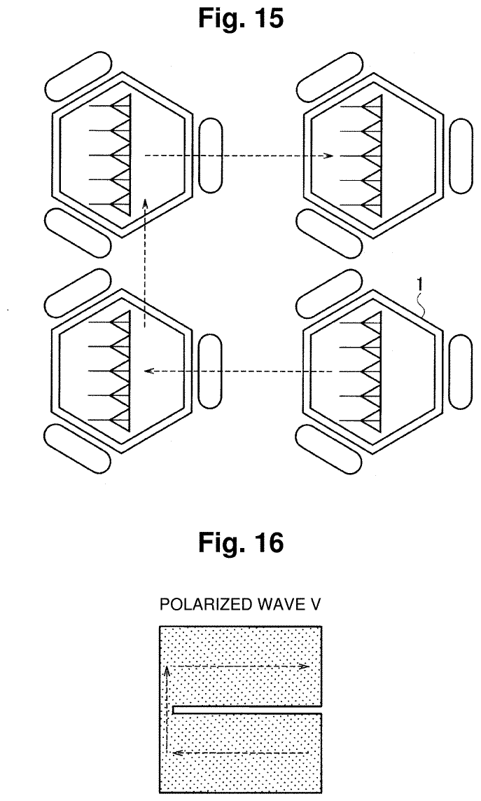

Since the ground penetrating radar device 1 can turn at the same spot, it is possible to change the plane of polarization to be measured by causing the ground penetrating radar device 1 to turn. At the end point of the movement locus of FIG. 13, the orientation of the ground penetrating radar device 1 is changed to the left. Subsequently, as illustrated in FIG. 15, the ground penetrating radar device 1 is moved to the left to perform radar measurement, and then the ground penetrating radar device 1 is moved upward without changing the orientation thereof so as to shift the measurement position. Subsequently, the ground penetrating radar device 1 is moved to the right to perform radar measurement. FIG. 16 illustrates measurement data of the polarized wave V obtained from the movement locus of FIG. 15.

The movements of FIG. 13 and FIG. 15 enable continuous single-stroke scanning. Conventional devices require, when performing measurement on a plurality of measurement lines, a manual work at a rough estimation to align each measurement line because only linear measurement lines are used. Since the ground penetrating radar device 1 of the present embodiment can perform single-stroke scanning, the burden of a worker during measurement can be reduced.

In addition, acquiring measurement data of various polarized waves by sequential scan can increase the amount of information, and highly accurate underground observation can be expected.

Next, focused measurement that can be realized by turning movements will be described.

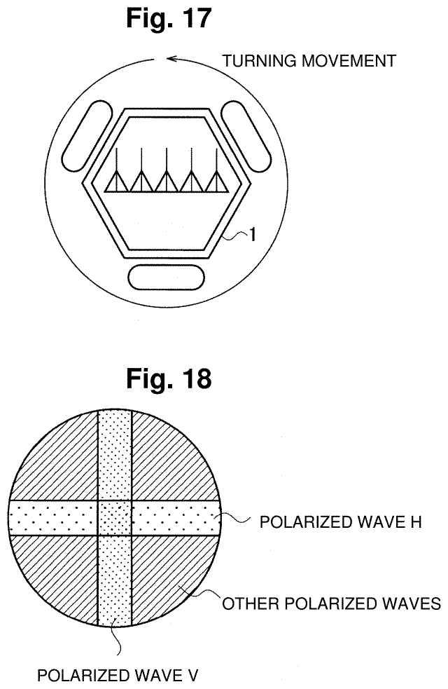

As illustrated in FIG. 16, the ground penetrating radar device 1 may be equipped with a transmission/reception antenna array in which multiple transmission/reception antennas are arranged side by side. FIG. 17 illustrates measurement data of polarized waves in various directions obtained when the ground penetrating radar device 1 of FIG. 16 is caused to turn at the same spot.

When an obstacle such as a utility pole is present in the measurement area, performing radar measurement in the vicinity of the obstacle while causing turning movements of the ground penetrating radar device 1 can obtain more detailed measurement data at a specific spot.

As described above, the ground penetrating radar device 1 according to the present embodiment is a manually operable device and includes three wheels 11A to 11 having axles angularly displaced from each other by 120 degrees and the encoders 12A to 12C attached to the axles. The control unit 14 calculates, from the rotation amounts measured by the encoders 12A to 12C, the moving direction, moving distance, moving speed vector, and turning vector of the ground penetrating radar device 1. The measurement unit 15 searches for an underground buried object with radio wave. The storage unit 17 stores the two-dimensional measurement data set, in which the positional information and directional information of the ground penetrating radar device 1 calculated by the control unit 14 is associated with the measurement data obtained by the radar measurement unit. The display unit 18 displays the facility map indicating the position where the underground structure is present, which is stored in the database 16, together with the measurement data while superimposing the facility map and the measurement data one on the other. As a result, handling performance of the ground penetrating radar device 1 can be improved. In addition, the two-dimensional measurement data set having high position reliability can be provided, and the burden of a worker during measurement can be reduced by visualizing the measurement range.

### REFERENCE SIGNS LIST

1 ground penetrating radar device
11, 11A to 11C wheel
12, 12A to 12C encoder
13 operation unit
14 control unit
15 measurement unit
16 database
17 storage unit
18 display unit
21 transmission unit
22 reception unit
23, 24 antenna
25 IMU
16 camera
100 buried pipe
110 manhole structure

1. A manually operable ground penetrating radar device, comprising:
three omnidirectional wheels having axles angularly displaced from each other by 120 degrees;
encoders attached to axles of the respective three omnidirectional wheels;
a position measurement unit configured to obtain positional information and directional information of the ground penetrating radar device from rotation amounts of the axles measured by the encoders;
a radar measurement unit configured to search for an underground buried object with radio wave;
a database storing a facility map indicating a position where the underground buried object is present;
a storage unit configured to store a two-dimensional measurement data set in which measurement data obtained by the radar measurement unit is associated with the positional information and the directional information; and
a display unit configured to display the facility map and the measurement data while superimposing the facility map and the measurement data one on the other.

2. The ground penetrating radar device according to claim 1, wherein
the storage unit stores the measurement data for each polarized component of the radio wave based on the directional information, and
the display unit displays the measurement data for each polarized component.

3. The ground penetrating radar device according to claim 1, further comprising:
a position identification unit configured to align positional information of a spot that can be identified from the measurement data with position coordinates of a corresponding spot on the facility map.

4. The ground penetrating radar device according to claim 1, further comprising:
a relative permittivity calculation unit configured to obtain an edaphic relative permittivity at a spot where a position to the underground buried object is known on the facility map based on underground propagation time of the radio wave at the spot and a distance from a ground surface to the underground buried object.

5. The ground penetrating radar device according to claim 1, further comprising:
an inner world sensor configured to measure the inclination of a road surface, and
a camera configured to capture an image of the road surface,
wherein the display unit displays a road surface inclination map measured by the inner world sensor and a road surface map captured by the camera while superimposing the road surface inclination map and the road surface map one on the other.

6. A measurement method that is executed by a manually operable ground penetrating radar device that includes three omnidirectional wheels having axles angularly displaced from each other by 120 degrees, the method comprising:
a step of obtaining positional information and directional information of the ground penetrating radar device from rotation amounts of the axles of the three omnidirectional wheels;
a step of searching for an underground buried object with radio wave;
a step of storing a two-dimensional measurement data set in which measurement data measured with the radio wave is associated with the positional information and the directional information; and
a step of displaying a facility map indicating a position where the underground buried object is present together with the measurement data while superimposing the facility map and the measurement data one on the other.

7. The measurement method according to claim 6, further comprising:
a step of aligning positional information of a spot that can be identified from the measurement data with position coordinates of a corresponding spot on the facility map.

8. The measurement method according to claim 6 or 7, further comprising:
a step of obtaining an edaphic relative permittivity at a spot where a position to the underground buried object is known on the facility map based on underground propagation time of the radio wave at the spot and a distance from a ground surface to the underground buried object.

9. The ground penetrating radar device according to claim 2, further comprising:
a position identification unit configured to align positional information of a spot that can be identified from the measurement data with position coordinates of a corresponding spot on the facility map.

10. The ground penetrating radar device according to claim 2, further comprising:
a relative permittivity calculation unit configured to obtain an edaphic relative permittivity at a spot where a position to the underground buried object is known on the facility map based on underground propagation time of the radio wave at the spot and a distance from a ground surface to the underground buried object.

11. The ground penetrating radar device according to claim 3, further comprising:
a relative permittivity calculation unit configured to obtain an edaphic relative permittivity at a spot where a position to the underground buried object is known on the facility map based on underground propagation time of the radio wave at the spot and a distance from a ground surface to the underground buried object.

12. The ground penetrating radar device according to claim 2, further comprising:
an inner world sensor configured to measure the inclination of a road surface, and
a camera configured to capture an image of the road surface,
wherein the display unit displays a road surface inclination map measured by the inner world sensor and a road surface map captured by the camera while superimposing the road surface inclination map and the road surface map one on the other.

13. The ground penetrating radar device according to claim 3, further comprising:
an inner world sensor configured to measure the inclination of a road surface, and
a camera configured to capture an image of the road surface,
wherein the display unit displays a road surface inclination map measured by the inner world sensor and a road surface map captured by the camera while superimposing the road surface inclination map and the road surface map one on the other.

14. The ground penetrating radar device according to claim 4, further comprising:
an inner world sensor configured to measure the inclination of a road surface, and
a camera configured to capture an image of the road surface,
wherein the display unit displays a road surface inclination map measured by the inner world sensor and a road surface map captured by the camera while superimposing the road surface inclination map and the road surface map one on the other.

15. The measurement method according to claim 7, further comprising:
a step of obtaining an edaphic relative permittivity at a spot where a position to the underground buried object is known on the facility map based on underground propagation time of the radio wave at the spot and a distance from a ground surface to the underground buried object.
